(19) United States
(12) Patent Application Publication
(10) Pub. No.: US 2008/0031118 A1
(43) Pub. Date: Feb. 7, 2008

(54) COMBINED HOLOGRAM OPTICAL ELEMENT, COMPATIBLE OPTICAL PICKUP AND OPTICAL INFORMATION STORAGE MEDIUM SYSTEM EMPLOYING THE SAME

(75) Inventors: Kyong-tae Park, Suwon-si (KR); Tae-kyung Kim, Seoul (KR); Jae-cheol Bae, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/830,923

(22) Filed: Jul. 31, 2007

(30) Foreign Application Priority Data
Aug. 1, 2006 (KR) 2006-72785
Jun. 28, 2007 (KR) 2007-64614

(51) Int. Cl. G11B 7/00

(52) U.S. Cl. 369/103

(57) ABSTRACT

A hologram optical element, usable in a compatible optical pickup including the hologram optical element and an optical information storage medium system including the compatible optical pickup, is used in combination with an objective lens for a compatible optical pickup used for first and second low-density information storage media using lights having a second wavelength and a third wavelength and at least one kind of high-density information storage medium using light having a first wavelength. The hologram optical element includes a combined hologram on one side to allow lights having the second wavelength and the third wavelength to travel at different angles for focusing the light onto the first and second low-density information storage media, respectively.

### CROSS-REFERENCE TO RELATED APPLICATIONS

This application claims the benefit of Korean Application No. 2006-72785, filed Aug. 1, 2006 in the Korean Intellectual Property Office, and Korean Patent Application No. 2007-64614, filed Jun. 28, 2007 in the Korean Intellectual Property Office, the disclosures of which are incorporated herein by reference.

### BACKGROUND OF THE INVENTION

1. Field of the Invention

Aspects of the present invention relate to a combined hologram optical element, a compatible optical pickup including the combined hologram optical element, and an optical information storage medium system including the compatible optical pickup, and more particularly, to a combined hologram optical element to be compatibly used between information storage media having different formats, a compatible optical pickup including the combined hologram optical element to be compatibly used between a digital versatile disc (DVD), a compact disc (CD), and at least one of a blu-ray disc (BD) and a high definition DVD (HD DVD) with using one objective lens, and an optical information storage medium system including the compatible optical pickup.

2. Description of the Related Art

Optical information storage medium systems are used to reproduce and record information from and to an information storage medium, such as an optical disc. Reproduction and recording are performed by forming a light spot on the information storage medium using a laser light and an objective lens. A recording capacity in optical information storage medium systems is determined by the size of a light spot formed on the information storage medium to reproduce and record information. The size of the light spot is determined by the wavelength λ of a laser light, and the numerical aperture of an objective lens as given by Equation 1 below.

Light spot diameter∝λ/NA Equation 1

Therefore, optical disc systems capable of forming a smaller light spot have be studied for storing high density data. The first generation optical disc is a CD which uses an infrared light. The second generation optical disc is a DVD which uses a red light. The third generation optical discs are a BD and a HD DVD which use a blue light. The CD and DVD use light having different wavelengths and require different formats (particularly, the numerical aperture of an objective lens, and disc thickness). The BD and HD DVD use light having the same wavelength but require different formats (particularly, the numerical aperture of an objective lens, and disc thickness). Therefore, the formats of commercialized current optical discs can be classified into four different formats. Since different optical discs require different numerical apertures, respectively optimized objective lenses are required for the four different optical discs (i.e., CD, DVD, BD, and HD-DVD).

A BD format requires light having a wavelength of about 405 nm and an objective lens having a numerical aperture of 0.85. The thickness of the BD (distance from a light entrance surface to an information storage surface of the BD) is 0.1 mm. The one-sided capacity of the BD is about 25 GB. An HD DVD format requires light having a wavelength same to the wavelength of light used for the BD. However, the HD DVD requires an objective lens having a numeral aperture of 0.65. The thickness of the HD DVD (measured from a light entrance surface to an information storage surface of the HD DVD) is 0.6 mm, and the one-sided capacity of the HD DVD is about 15 GB.

As described above, since there are four formats of commercialized current optical discs, an optical disc system compatible with these four kinds of formats is required. In Japanese Patent Publication No. 2005-129227, an optical disc apparatus to record/reproduce for a BD and a DVD are disclosed. The disclosed apparatus uses an objective lens coupled with a phase hologram. The phase hologram transmits zero-th order diffraction light for a BD and diverges first order diffraction light for a DVD. In the disclosed apparatus, zero-th order diffraction light is used for a BD, and first order diffraction light is used for a DVD by using the phase hologram. However, the disclosed apparatus can be used for only two kinds of optical discs although more kinds of optical discs have become commercially available. Therefore, there is a need for an apparatus that can be used for all kinds of optical discs using one objective lens and a hologram element.

### SUMMARY OF THE INVENTION

Aspects of the present invention provide a combined hologram optical element to adopt compatibly different information storage media, a compatible optical pickup including the combined hologram optical element to adopt compatibly a digital versatile disc (DVD), a compact disc (CD), and at least one of a blu-ray disc (BD) and a high definition DVD (HD DVD) with using single objective lens, and an optical information storage medium system including the compatible optical pickup.

According to an aspect of the present invention, there may be provided a hologram optical element used in combination with an objective lens for a compatible optical pickup used for first and second low-density information storage media using lights having a second wavelength and a third wavelength and at least one kind of high-density information storage medium using light having a first wavelength, the hologram optical element including a combined hologram on one side to allow lights having the second wavelength and the third wavelength to travel at different angles for focusing the lights onto the first and second low-density information storage media, respectively.

According to an aspect of the present invention, the combined hologram includes: a first hologram transmitting light having the third wavelength without deflection and diffracting light having the second wavelength so as to focus the light having the second wavelength onto the first low-density information storage medium; and a second hologram transmitting light having the second wavelength without deflection and diffracting light having the third wavelength so as to focus the light having the third wavelength onto the second low-density information storage medium.

According to an aspect of the present invention, the first and second holograms are formed in a two-layer structure to have the same optical axis.

According to an aspect of the present invention, each of the first and second holograms has a stepped shape.

According to an aspect of the present invention, the first hologram may be formed to have maximum transmission efficiency for zero-th order diffraction light having the third wavelength, and the second hologram may be formed to have maximum transmission efficiency for zero-th order diffraction light having the second wavelength.

According to an aspect of the present invention, the hologram optical element may further a third hologram formed on an opposite side to the combined hologram to diffract light having the first wavelength by zero-th and first order diffractions, wherein the zero-th order diffraction light having the first wavelength may be transmitted through the third hologram without deflection and may be focused onto a first high-density information storage medium, and the first order diffraction light having the first wavelength may be diverged from the third hologram and may be focused onto a second high-density information storage medium so that the first and second high-density information storage media having different thicknesses and using the light having the first wavelength are compatibly used.

According to an aspect of the present invention, the first hologram has an outer diameter so that a combination of the first hologram and the objective lens makes a numerical aperture suitable for the first low-density information storage medium with respect to light having the second wavelength, and the second hologram has an outer diameter so that a combination of the second hologram and the objective lens makes a numerical aperture suitable for the second low-density information storage medium with respect to light having the third wavelength.

According to an aspect of the present invention, the objective lens may be formed to have a numerical aperture suitable for the first high-density information storage medium with respect to the zero-th diffraction light having the first wavelength, and the third hologram has an outer diameter so that a combination of the third hologram and the objective lens makes a numerical aperture suitable for the second high-density information storage medium with respect to the first order diffraction light having the first wavelength.

According to an aspect of the present invention, the numerical apertures suitable for the first and second high-density information storage media are 0.85 and 0.65, respectively, and one of the numerical apertures suitable for the first and second low-density information storage media may be 0.6 and the other may be 0.45.

According to an aspect of the present invention, the first and second high-density information storage media satisfy a blue-ray disc (BD) standard and a high definition digital versatile disc (HD DVD) standard, standard respectively, and one of the first and second low-density information storage media satisfy a DVD and the other satisfy a compact disc (CD) standard, wherein the light of the first wavelength may be a blue-light, and one of the lights of the second and third wavelengths may be a red-light and the other may be an infrared-light.

According to an aspect of the present invention, the first hologram has an outer diameter so that a combination of the first hologram and the objective lens makes a numerical aperture suitable for the first low-density information storage medium with respect to light having the second wavelength, and the second hologram has an outer diameter so that a combination of the second hologram and the objective lens makes a numerical aperture suitable for the second low-density information storage medium with respect to light having the third wavelength.

According to an aspect of the present invention, the objective lens may be formed to have a numerical aperture suitable for the high-density information storage medium with respect to light having the first wavelength.

According to an aspect of the present invention, the numerical aperture suitable for the high-density information storage medium may be at least one of 0.85 and 0.65, and one of the numerical apertures suitable for the first and second low-density information storage media may be 0.6 and the other may be 0.45.

According to an aspect of the present invention, the high-density information storage medium satisfies at least one of a BD standard and a HD DVD standard, and one of the first and second low-density information storage media satisfies a DVD standard and the other satisfies a CD standard, wherein the light of the first wavelength may be a blue-light, and one of the lights of the second and third wavelengths may be a red-light and the other may be an infrared-light.

According to another aspect of the present invention, there may be provided a compatible optical pickup including: an optical system directing light having first, second, and third wavelengths to an information storage medium and detecting the light reflected from the information storage medium, wherein light having the first wavelength being suitable for at least one kind of high-density information storage medium, light having the second wavelength being suitable for a first low-density information storage medium, light having the third wavelength being suitable for a second low-density information storage medium; an objective lens focusing incident light onto the information storage medium; and a hologram optical element having at least one of the characteristics described above disposed between the optical system and the objective lens.

According to another aspect of the present invention, there may be provided an optical information storage medium system including a compatible optical pickup and a control unit controlling the compatible optical pickup.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become more apparent and more readily appreciated from the following description of the embodiments, taken in conjunction with the accompanying drawings of which:

FIG. 1 is a schematic view illustrating a compatible optical pickup including a hologram optical element according to an embodiment of the present invention;

FIG. 2 is an enlarged view illustrating the hologram optical element, an objective lens and, an information storage medium, and illustrating optical paths of the compatible optical pickup depicted in FIG. 1, according to an embodiment of the present invention;

FIG. 3A is a view illustrating divergence of light of a second wavelength λ2 by diffracting from a second hologram of FIG. 2 and light of a third wavelength λ3 passing straight through the second hologram;

FIG. 3B is a view illustrating divergence of light of a third wavelength λ3 by diffracting from a third hologram of FIG. 2 and light of a second wavelength λ2 passing straight through the third hologram;

FIG. 3C is a view illustrating optical paths of second and third wavelengths λ2 and λ3 when the second and third holograms are formed in a two-layer structure;

FIG. 4 is a schematic view illustrating a compatible optical pickup including a hologram optical element according to another embodiment of the present invention;

FIG. 5 is an enlarged view illustrating the hologram optical element, an objective lens, and an information storage medium, and illustrating optical paths of the compatible optical pickup depicted in FIG. 4, according to another embodiment of the present invention; and

FIG. 6 is a schematic view illustrating an optical information storage medium system including a compatible optical pickup according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

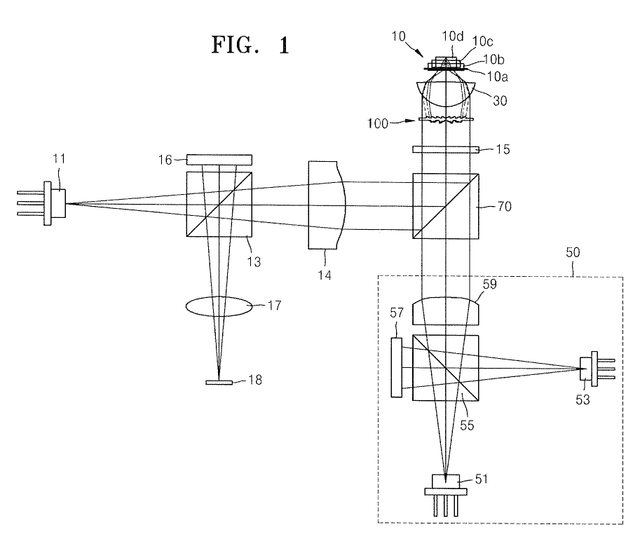

FIG. 1 is a schematic view illustrating a compatible optical pickup including a hologram optical element 100 according to an embodiment of the present invention. The shown compatible optical pickup can be used for four kinds of information storage media having different formats each other. However, it is understood that the compatible optical pickup could be compatible with additional formats in other aspects of the invention.

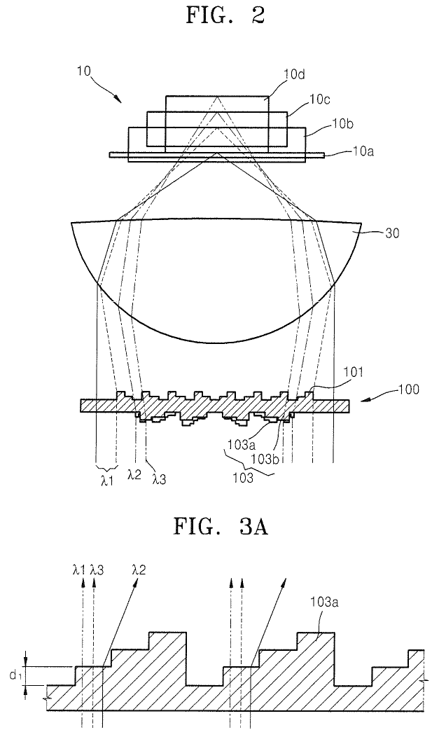

Referring to FIG. 1, according to an embodiment of the present invention, the compatible optical pickup includes an optical system, an objective lens 30, and a hologram optical element 100. The optical system emits light having a first wavelength λ1 used for a blu-ray disc (BD)10a and a high definition digital versatile disc (HD DVD) 10b, light having a second wavelength λ2 used for a DVD 10c, and light having a third wavelength λ3 used for a compact disc (CD) 10d toward an information storage medium 10. The optical system detects light having first through third wavelengths reflected from the information storage medium 10. The objective lens 30 is optimized for a high-density information storage medium, such as the BD 10a. Referring to FIG. 2, the hologram optical element 100 is disposed between the optical system and the objective lens 30 includes a combined hologram 103 on one side and a first hologram 101 on the other side. The combined hologram 130 includes a second hologram 103a and a third hologram 103b.

The BD 10a and the HD DVD 10b are high-density information storage media that have different thicknesses and require light having the same wavelength and different numerical apertures of an objective lens. The DVD 10c and the CD 10d are low-density information storage media that have different thicknesses and require light having different wavelengths and different numerical apertures of an objective lens.

In the shown embodiment of FIG. 1, the optical system is configured with three light sources 11, 51 and 53 and one photodetector 18. In detail, the optical system includes: a first light source 11 emitting light having the first wavelength λ1 for high-density information storage media such as the BD 10a the HD DVD 10b; a first optical path changer 13 disposed between the objective lens 30 and the first light source 11 for changing an optical path; a photodetector 18 receiving light reflected from the information storage medium 10 through the objective lens 30 and the first optical path changer 13; a low-density optical system 50 used for low-density information storage media; and a first optical path coupler 70 combining optical path of light emitted from the low-density optical system 50 with the optical path of the light emitted from the first light source 11 so that the light emitted from the low density optical system 50 is also directed to the objective lens 30. The low-density optical system 50 includes a second light source 51 emitting light having the second wavelength λ2 for a first low-density information storage medium such as the DVD 10c, and a third light source 53 emitting light having a third wavelength λ3 for a second low-density information storage medium such as the CD 10d. Therefore, the low-density optical system 50 can be used for two kinds of low-density information storage media, such as the DVD 10c and the CD 10d. A second light coupler 55 transmits the second wavelength light λ2 to the first light coupler 70, and reflects the third wavelength λ3 to the first light coupler 70.

The first light source 11 emits light having the first wavelength λ1 that is commonly used for a first high-density information storage medium such as the BD 10a having a thickness of about 0.1 mm and a second high-density information storage medium such as the HD DVD 10b having a thickness of about 0.6 mm. For example, when the first and second information storage media are the BD 10a and the HD DVD 10b, the first light source 11 emits blue light having a wavelength of about 405 nm. A semiconductor laser can be used for the first light source 11, but the light source is not so limited.

In the shown embodiment, the compatible optical pickup further includes a collimating lens 14 to collimate light of the first wavelength λ1 emitted from the first light source 11 into a parallel light. However, it is understood that the collimating lens 14 need not be used, or can be otherwise located for use with the first wavelength λ1, second wavelength λ2, and/or third wavelength λ3.

The first optical path changer 13 transmits light having the first wavelength λ1 emitted from the first light source 11. However, the first optical path changer 13 reflects light having the first through third wavelengths λ1, λ2, and λ3 reflected from the information storage medium 10 so as to direct the light to the photodetector 18. For example, the first optical path changer 13 may be a polarizing beam splitter that transmits p-polarized light of the first wavelength λ1 emitted from the first light source 11, and reflects s-polarized light having the first through third wavelengths λ1, λ2, and λ3 reflected from the information storage medium 10 toward the photodetector 18.

In the shown example, a quarter wave plate 15 is disposed in the middle of a common optical path of the first through third wavelengths λ1, λ2, and λ3 to change the polarization of light. For example, the quarter wave plate 15 is disposed between the hologram optical element 100 and the first optical path coupler 70 as shown. However, it is understood that the quarter wave plate 15 need not be used or can be otherwise located. Moreover, multiple quarter wavelength plates can be used.

The shown low-density optical system 50 includes the second and third light sources 51 and 53 that emit light suitable for the first and second low-density information storage media. For example, when the first and second information storage media are the DVD 10c having a thickness of 0.6 mm and the CD 10d having a thickness of 1.2 mm, the second light source 51 may emit red light for the DVD 10c, and the third light source 53 may emit infrared light for the CD 10d. The shown low-density optical system 50 further includes the second optical path coupler 55 for combining optical path of light emitted from the second light source 51 with optical path of light emitted from the third light source 53 so as to direct the lights along the same optical path to the first optical path coupler 70. The shown low-density optical system 50 further includes a collimating lens 59 disposed between the first optical path coupler 70 and the second optical path coupler 55 for collimating the lights from the second light source 51 and the third light source 53 into a parallel light. However, it is understood that the optical system 50 is not limited thereto.

The second light source 51 emits light having the second wavelength λ2 for the DVD 10c. For example, the second light source 51 may emit red light having a wavelength of about 650 nm. The third light source 53 emits light having the third wavelength λ3 for the CD 10d. For example, the third light source 53 may emit infrared light having a wavelength of about 780 nm.

When the first optical path changer 13 is a polarizing beam splitter transmitting p-polarized light and reflecting s-polarized light, and the quarter wave plate 15 is disposed between the first optical path coupler 70 and the objective lens 30, the second and third light sources 51 and 53 may emit p-polarized light. In this case, the second optical path coupler 55 may be a polarizing beam splitter that transmits p-polarized light having the second wavelength λ2 emitted from the second light source 51, and reflects p-polarized light having the third wavelength λ3 emitted from the third light source 53. The second optical path coupler 55 combines optical path of light having the second wavelength λ2 with optical path of light having the third wavelength λ3 so as to direct the lights along the same optical path.

Light having the first through third wavelengths λ1, λ2, and λ3 reflected from the information storage medium 10 can be reflected by the first optical path coupler 70 toward the first optical path changer 13. For this, the first optical path coupler 70 may be formed to reflect blue light used for the BD 10a and the HD DVD 10b regardless of the polarization of the blue light, and selectively transmit or reflect light emitted from the low-density optical system 50 for the DVD 10c and the CD 10d according to the polarization of the light. For example, the first optical path coupler 70 may be formed to reflect light having the first wavelength λ1 regardless of the polarization of the light, transmits p-polarized light having the second and third wavelengths λ2 and λ3 emitted from the second and third light sources 51 and 53, and reflects s-polarized light having the second and third wavelengths λ2 and λ3 reflected from the information storage medium 10 and transmitted through the quarter wave plate 15.

In FIG. 1, a monitoring photodetector 16 detects the optical output power of the first light source 11 used for the BD 10a and the HD DVD 10b. A monitoring photodetector 57 detects the optical output powers of the second light source 51 and the third light source 53 used for the DVD 10c and the CD 10d. Tracking errors of the BD 10a and the HD DVD 10b can be detected using a three-beam method by disposing a grating (not shown) at an optical path between the first light source 11 and the first optical path changer 13 to divide light having the first wavelength λ1 emitted from the first light source 11 into three light beams. In addition, another grating (not shown) can be disposed on an optical path along which light emitted from the second light source 51 or the third light source 53 travels.

The above-described optical system is an exemplary one that can be included in the compatible optical pickup of the present invention. That is, the structure of the optical system can be changed or modified. For example, the optical system can include a DVD hologram optical module instead of the second light source 51, and a CD hologram optical module instead of the third light source 53. In this case, the photodetector 18 may detect light reflected only from the BD 10a and the HD DVD 10b. Meanwhile, the DVD hologram optical module can include a light source emitting red light having a wavelength of about 650 nm, and the CD hologram optical module can include a light source emitting infrared light having a wavelength of about 780 nm. Furthermore, the quarter wave plate 15 can be disposed between the optical path changer 13 and the first optical path coupler 70. Each of the DVD and CD hologram optical modules may include a light source, a photodetector and a hologram. The hologram may transmit light emitted from the light source straight (i.e., without diffraction) and direct reentering light reflected from the information storage medium 10 to the photodetector by first-order diffraction. The hologram may be formed on one side of a transparent member, and a grating pattern may be further formed on the other side of the member. The grating pattern is used to divide incident light into three beams so that tracking errors can be detected by using a three-beam method. Such a hologram optical module is well known to one of ordinary skill in the related art. Thus, a detailed description of the hologram optical module will be omitted.

The objective lens 30 condenses incident light onto the information storage medium 10, which generically refers to the BD 10a, HD-DVD 10b, DVD 10c, and CD 10d. The objective lens 30 can be optimized for the first low-density information storage medium such as the BD 10a. For example, when parallel light (zero-th order diffraction light passing straight through the first hologram 101 of the hologram optical element 100) having the first wavelength λ1 of about 405 nm is incident, the objective lens 30 may be designed to from an optimized light spot on the BD 10a having a thickness of about 0.1 mm using the incident parallel light by an effective numerical aperture of about 0.85. However, it is understood that the objective lens 30 could be optimized for the HD-DVD 10b, the DVD 10c, or the CD 10d.

Owing to the combination of the hologram optical element 100 and the objective lens 30, all the first and second high-density information storage media and the first and second low-density information storage media can be used. Hereinafter, the BD 10a, the HD DVD 10b, the DVD 10c, and the CD 10d will be respectively referred to as the first high-density information storage medium, the second high-density information storage medium, the first low-density information storage medium, and the second low-density information storage medium.

Referring to FIG. 2, as described above, the hologram optical element 100 includes the combined hologram 103 formed on one side facing the optical system (i.e., not facing the objective lens 30). The first hologram 101 is on the other side facing the objective lens 30. The combined hologram 103 includes the second and third holograms 103a and 103b. The combined hologram 103 transmits light having the second wavelength λ2 for the DVD 10c and light having the third wavelength λ3 for the CD 10d at different angles so that the light having the second wavelength λ2 can be focused on the DVD 10c and the light having the third wavelength λ3 can be focused on the CD 10d. The first hologram 101 diffracts light having the first wavelength λ1 for the BD 10a and the HD DVD 10b to be a zero-th order diffraction light and a first order diffraction light. The first hologram 101 transmits zero-the order diffraction light of the first wavelength λ1 without diffraction, and diverges first order diffraction light having of first wavelength λ1. However, it is understood that the holograms 101, 103 can be disposed to opposite sides to those shown.

The second hologram 103a transmits light having third wavelength λ3 without diffraction and diffracts light having the second wavelength λ2 so as to focus the light having the second wavelength λ2 onto the DVD 10c. The third hologram 103b transmits light having the second wavelength λ2 without diffraction and diffracts light having the third wavelength λ3 so as to focus the light having the third wavelength λ3 onto the CD 10d. The second and third holograms 103a and 103b may be formed to transmit most of light having the first wavelength λ1 without deflection.

Owing to the combination of the objective lens 30 and the second and third holograms 103a and 103b, it is preferable, but not required, that numerical apertures (e.g., 0.6 and 0.45) are obtained for the second and third wavelengths λ2 and λ3 used for the DVD 10c and the CD 10d.

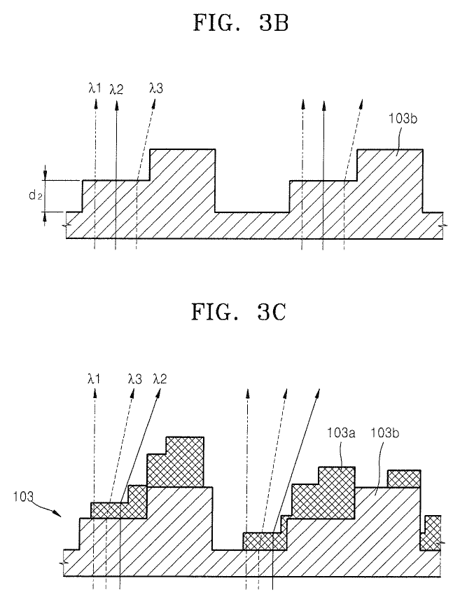

FIG. 3A is a view illustrating divergence of light having the second wavelength λ2 due to diffracting from the second hologram 103a, and light having the first wavelength λ1 and the third wavelength λ3 passing straight through the second hologram 103a. FIG. 3B is a view illustrating divergence of light having the third wavelength λ3 due to diffracting from the third hologram 103b, and light having the first wavelength λ1 and the second wavelength λ2 passing straight through the third hologram 103b. FIG. 3C is a view illustrating optical paths of lights having the second and third wavelengths λ2 and λ3 when the second and third holograms 103a and 103b are formed in a two-layer structure.

Referring to FIGS. 2 and 3C, the second and third holograms 103a and 103b have the same optical axis and formed in a two-layer structure. Each of the second and third holograms 103a and 103b has a stepped structure. However, it is understood that the holograms 103a, 103b can have different axes and/or other structures that that shown.

The second hologram 103a may be designed for diffracting light having the second wavelength λ2 and transmitting zero-th order diffraction light having the third wavelength λ3 at the maximum transmission efficiency. The third hologram 103b may be designed for diffracting light having the third wavelength λ3 and transmitting zero-th order diffraction light having the second wavelength λ2 at the maximum transmission efficiency. While not required in all aspects, the second hologram 103a and/or third hologram 103b may be further designed to transmit zero-th order diffraction light having the first wavelength λ1 at the maximum transmission efficiency, or at a lesser efficiency.

Referring to FIG. 3A, when the second hologram 103a is designed so that the height d₁ of one step is expressed by d₁=(n_{λ3}−1)*m1, where m1 is an integer and n_{λ3} is the refractive index for the third wavelength λ3, the second hologram 103a can be formed to have the maximum transmission efficiency of zero-th order diffraction with respect to light having the third wavelength λ3.

Referring to FIG. 3B, when the third hologram 103b is designed so that the height d₂ of one step is expressed by d₂=(n_{λ2}−1)*m2, where m2 is an integer and n_{λ2} is the refractive index for the second wavelength λ2, third hologram 103b can be formed to have the maximum transmission efficiency of zero-th order diffraction with respect to light having the second wavelength λ2.

While not required, it is understood that heights d1, d2 can be further optimized to transmit the first wavelength λ1 as zero^{th} order diffraction.

The outer diameter of the second hologram 103a may be properly selected so that the combination of the objective lens 30 and the second hologram 103a make a numerical aperture (e.g., 0.6) suitable for the DVD 10c. The outer diameter of the third hologram 103b may be properly selected so that the combination of the objective lens 30 and the third hologram 103b make a numerical aperture (e.g., 0.45) suitable for the CD 10d.

The first hologram 101 is formed to transmit zero-th order diffraction light having the first wavelength λ1 without deflection, and diverges first diffraction light having the first wavelength λ1 so that the zero-th order diffraction light having the first wavelength λ1 can be focused onto the BD 10a, and the first order diffraction light having the first wavelength λ1 can be focused onto the HD DVD 10b. The first hologram 101 can be optimized to transmit the second and third wavelengths λ1, λ2 as zero^{th} order light.

In this example, the objective lens 30 may be formed to make a numerical aperture (e.g., 0.85) suitable for the BD 10a with respect to the zero-th order diffraction light having the first wavelength λ1 and the outer diameter of the first hologram 101 may be properly selected so that the combination of the first hologram 101 and the objective lens 30 make a numerical aperture (e.g., 0.65) suitable for the HD DVD 10b.

When, the hologram optical element 100 as above described is combined with the objective lens 30 that have a numerical aperture of 0.85, the hologram optical element 100 includes a function of phase compensation due to diffraction. The hologram optical element 100 is structured such that the first hologram 101 is formed in a concentric-circle shape on a top side of the hologram optical element 100 to be suitable for the BD 10a and the HD DVD 10b, and the second and third holograms 103a and 103b are formed on a bottom side of the hologram optical element 100 to be suitable for the DVD 10c and the CD 10d.

Owing to the configuration of the single objective lens 30 and the single hologram optical element 100, the compatible optical pickup can be used for the first and second high-density information storage media and the first and second low-density information storage media. The first high-density information storage medium may be a BD, and the second high-density information storage medium may be a HD DVD. One of the first and second low-density information storage media may be a DVD, and the other may be a CD. The first high-density information storage medium may have a thickness of about 0.1 mm, and the second high-density information storage medium may have a thickness of about 0.6 mm. One of the first and second low-density information storage media may have a thickness of about 0.6 mm, and the other may have a thickness of about 1.2 mm. Here, each of the thicknesses of the media is measured from a light entrance surface to an information storage surface of the medium. However, it is understood that aspects can be used for compatibility with media of other formats, thickness and/or wavelength.

Light having the first wavelength λ1 passing through the bottom of the hologram optical element 100 travels to the top of the hologram optical element 100 in the form of parallel light with a small optical transmission loss. At the first hologram 101 formed on the top of the hologram optical element 100, the light having the first wavelength λ1 is divided into a zero-th order beam and a first order beam. The zero-th order beam passes straight through the first hologram 101 without diffraction toward the objective lens 30, so that the combination of the hologram optical element 100 and the objective lens 30 can make a light spot by a numerical aperture of 0.85 for the zero-th order beam. Meanwhile, the first order beam diverges from the hologram optical element 100 toward the objective lens 30 because of diffraction, so that the combination of the hologram optical element 100 and the objective lens 30 can make a light spot by a numerical aperture of 0.65 for the first order beam. Since the light spot due to the numerical aperture of 0.85 is suitable for recording/reproducing of the BD 10a, and the light spot due to the numerical aperture of 0.65 is suitable for recording/reproducing of the HD DVD 10b, and the compatible optical pickup can be used for both the BD 10a and the HD DVD 10b. Since focal lengths of the light spot for BD 10a made from the zero-th order beam and the light spot for the HD DVD 10b, made from the first order beam are different each other, light having the first wavelength λ1 passed through the hologram optical element 100 form separated two light spots.

The outer diameter of a diffraction pattern formed in the first hologram 101 in a concentric-circle structure is selected so that the combination of the first hologram 101 and the objective lens 30 can make a numerical aperture of 0.65 suitable for the HD DVD 10b.

The combined hologram 103 formed on the bottom of the hologram optical element 100 includes the second and third holograms 103a and 103b so that the combination of the objective lens 30 and the second and third holograms 103a and 103b can provide numerical apertures respectively to be able to make proper light spot for the DVD 10c and the CD 10d.

The diffraction efficiency of a single-layer hologram device is 100% when (n_{λ}−1)d=mλ. Thus, two holograms can be combined into one.

Therefore, as described in FIGS. 3A through 3C, the second hologram 103a for the DVD 10c is designed to have efficiency of about 100% for a zero-th order beam having a wavelength of about 780 nm, so that the second hologram 103a does not function as a diffraction element but functions as a flat plate for the 780-nm wavelength suitable for the CD 10d. That is, the 780-nm wavelength for the CD 10d passes through the second hologram 103a without diffraction.

Similarly, the third hologram 103b for the CD 10d is designed to have efficiency of about 100% for a zero-th order beam having a wavelength of about 650 nm, so that the third hologram 103b does not function as a diffraction element but functions as a flat plate for the 680-nm wavelength suitable for the DVD 10c. That is, the 650-nm wavelength for the DVD 10c passes through the third hologram 103b without diffraction. Since light is not diffracted by a flat plate disposed on an optical path, a hologram for DVD and a hologram for CD can be combined to have the same optical axis so as to use two wavelengths individually as described above. Therefore, a DVD/CD compatible hologram can be realized.

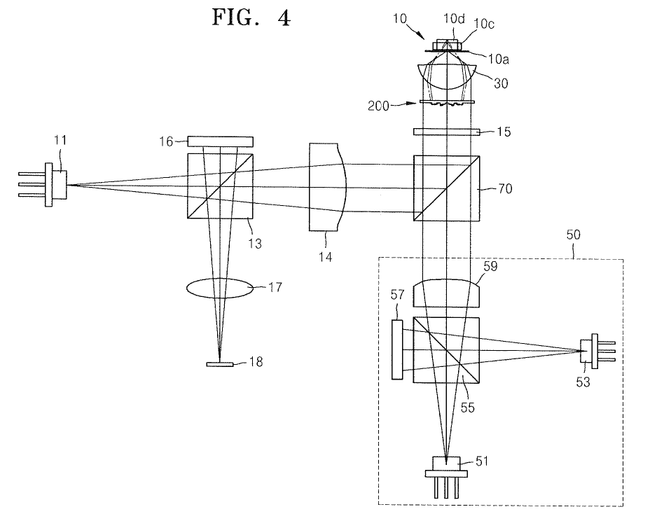

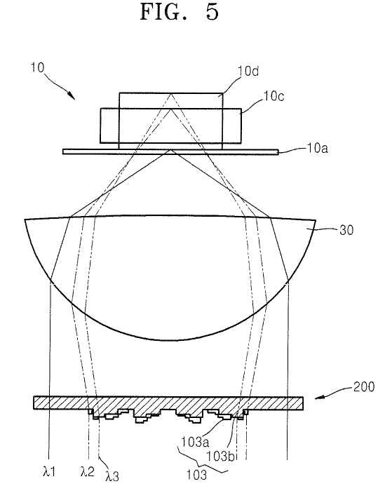

In the above-described embodiment, the hologram optical element 100 includes the combined hologram 103 on one side and the first hologram 101 on the other side. However, the present invention is not limited thereto. For example, according to another embodiment of the present invention, a hologram optical element 200 includes only a combined hologram 103 but does not include a first hologram 101 as shown in FIGS. 4 and 5. In this case, a compatible optical pickup using the hologram optical element 200 can be used for the DVD 10c, the CD 10d, and one of the BD 10a and the HD DVD 10b. That is, the compatible optical pickup can be used for one kind of high-density information storage medium and two kinds of low-density information storage media.

FIG. 4 is a schematic view illustrating a compatible optical pickup according to another embodiment of the present invention, and FIG. 5 is an enlarged view illustrating the hologram optical element 200, an objective lens 30, and an information storage medium 10, and illustrating optical paths of the compatible optical pickup depicted in FIG. 4, according to another embodiment of the present invention. In FIGS. 1 through 5, like reference numerals denote similar or like elements, and thus their description will be omitted here.

Referring to FIGS. 4 and 5, the compatible optical pickup includes the hologram optical element 200. The hologram optical element 200 includes the combined hologram 103, which is similar to that shown in FIGS. 3A to 3C. However, the first hologram 101 included in the hologram optical element 100 shown in FIGS. 3A-3C is not included in the hologram optical element 200. When the objective lens 30 of the compatible optical pickup is optimized for a BD 10a, the compatible optical pickup can be used for the BD 10a, a DVD 10c, and a CD 10d.

In the embodiment of FIG. 4, the compatible optical pickup is designed for the BD 10a, the DVD 10c, and the CD 10d. Alternatively, in another embodiment, the objective lens 30 can be optimized for the HD DVD 10b. In this case, the compatible optical pickup can be used for the HD DVD 10b, the DVD 10c, and CD 10d. This embodiment can be easily derived from the embodiment of FIG. 4, and thus a description thereof will be omitted here. Moreover, while the combined hologram 103 is shown in FIG. 4 facing away from the objective lens 30, it is understood the hologram 103 can be on a side facing the objective lens 30.

As described above, according to aspects of the present invention, the hologram optical element includes the combined hologram 103 on one side. The hologram optical element can further include the first hologram 101 on the other side for the BD 10a and the HD DVD 10b. Therefore, the compatible optical pickup including the hologram optical element can be used for the DVD 10c, the CD 10d, and at least one of the BD 10a and the HD DVD 10b. In other words, the compatible optical pickup according to aspects of the present invention can be used for two kinds of low-density information storage media and at least one kind of high-density information storage medium.

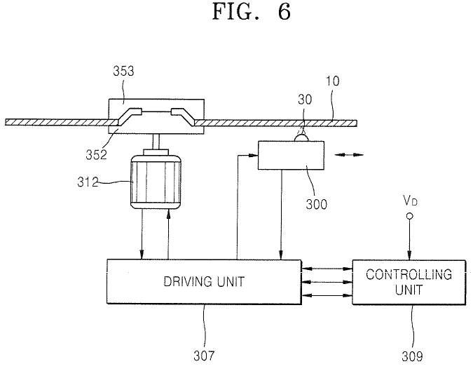

FIG. 6 is a schematic view illustrating an optical information storage medium system including a compatible optical pickup according to an embodiment of the present invention. Referring to FIG. 6, the optical information storage medium system includes a spindle motor 312, an optical pickup 300, a driving unit 307, and a control unit 309. The spindle motor 312 rotates the information storage medium 10 while on a turntable 352. The optical pickup 300 is installed to move in a radial direction relative to the information storage medium 10 for reproducing and recording information from and to the information storage medium 10. The driving unit 307 drives the spindle motor 312 and the optical pickup 300. The control unit 309 controls focusing, tracking, and/or tilting servos of the optical pickup 300. A clamp 353 holds the information storage medium 10 while on the turntable 352. The control unit 309 receives input V_{D} (such as from a user) to perform recording/reproduction.

The above-described compatible optical pickup can be used as the optical pickup device 300.

Light reflected from the information storage medium 10 is detected by the photodetector 18 included in the optical pickup device 300. The photodetector 18 generates an electric signal from detected light by photoelectric conversion. The electric signal is sent to the control unit 309 through the driving unit 307. The driving unit 307 controls the rotation speed of the spindle motor 312, amplifies an input signal, and drives the optical pickup device 300. The control unit 309 sends focusing, tracking, and/or tilting servo commands to the driving unit 307 based on the electric signal received from the optical pickup device 300 through the driving unit 307 to be realized focusing, tracking, and/or tilting operations of the optical pickup device 300.

Although the optical information storage medium system includes only one objective lens optimized for the BD 10a, the optical information storage medium system can be used for the BD 10a, the HD DVD 10b, the DVD 10c, and the CD 10d when the compatible optical pickup of the optical information storage medium system includes the hologram optical element 100. Alternatively, although the optical information storage medium system includes only one objective lens 30 optimized for the BD 10a or the HD DVD 10b, the optical information storage medium system can be used for the DVD 10c, the CD 10d, and one of the BD 10a and the HD DVD 10b when the compatible optical pickup of the optical information storage medium system includes the hologram optical element 200. Moreover, while described as separate, it is understood the ones of the elements in the optical system can be combined such that the combined hologram 103 and/or the hologram 101 can be included on other surfaces, such as a surface of the objective lens 30. Lastly, while the hologram optical element 100 is shown as being substantially flat and without curvature such that the lights pass through without further diffraction other than that provided by the holograms 101, 103, it is understood that one or both of the surfaces can be curved to aid in focusing or de-focusing of the lights.

As described above, according to the present invention, a DVD, a CD, and at least one of a BD and an HD DVD can be compatibly used owing to the combined hologram optical element, and only one objective lens.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A hologram optical element used in combination with an objective lens for a compatible optical pickup used for a first low-density information storage medium using a second light having a second wavelength, a second low-density information storage medium using a third light having a third wavelength other than the second wavelength, and at least one kind of high-density information storage medium using first light having a first wavelength other than the second and third wavelengths, the hologram optical element comprising:
a surface on which is disposed a combined hologram to allow the second and third lights to travel at different first and second angles for respectively focusing the second and third lights onto the first and second low-density information storage media.

2. The hologram optical element of claim 1, wherein:
the combined hologram comprises:
a first hologram transmitting the third light without deflection and diffracting the second light so as to focus the second light onto the first low-density information storage medium; and
a second hologram transmitting the second light without deflection and diffracting the third light so as to focus the third light onto the second low-density information storage medium, and
the first and second holograms transmit the first light without deflection.

3. The hologram optical element of claim 2, wherein the first and second holograms are formed in a two-layer structure on the surface to have a common optical axis.

4. The hologram optical element of claim 3, wherein each of the first and second holograms has a stepped shape.

5. The hologram optical element of claim 2, wherein:
the first hologram has a maximum transmission efficiency for zero-th order diffraction of the third light, and
the second hologram has a maximum transmission efficiency for zero-th order diffraction of the second light.

6. The hologram optical element of claim 2, further comprising another surface opposite the surface with the combined hologram, the another surface having a third hologram which diffracts the first light having by zero-th and first order diffractions,
wherein:
the zero-th order diffracted first light is transmitted through the third hologram without deflection and is focused onto a first kind of the at least one high-density information storage media having a first thickness, and
the first order diffracted first light is diverged by the third hologram and is focused onto a second kind of the at least one high-density information storage medium having a second thickness other than the first thickness so that the first and second high-density information storage media having different thicknesses compatibly use the light having the first wavelength.

7. The hologram optical element of claim 6, wherein:
the first hologram has an outer diameter so that a combination of the first hologram and the objective lens makes a numerical aperture suitable for the first low-density information storage medium with respect to the second light, and
the second hologram has an outer diameter so that a combination of the second hologram and the objective lens makes a numerical aperture suitable for the second low-density information storage medium with respect to the third light.

8. The hologram optical element of claim 7, wherein:
the objective lens is formed to have a numerical aperture suitable for the first high-density information storage medium with respect to the zero-th order diffracted first light, and
the third hologram has an outer diameter so that a combination of the third hologram and the objective lens makes a numerical aperture suitable for the second high-density information storage medium with respect to the first order diffracted first light.

9. The hologram optical element of claim 8, wherein:
the numerical aperture suitable for the first high-density information storage medium is 0.85,
the numerical aperture suitable for the second high-density information storage medium is 0.65,
one of the numerical apertures suitable for the first and second low-density information storage media is 0.6, and
the other one of the numerical apertures suitable for the first and second low-density information storage media is 0.45.

10. The hologram optical element of claim 8, wherein:
the first and second high-density information storage medium satisfies a blue-ray disc (BD) standard,
the second high-density information storage medium satisfies a high definition digital versatile disc (HD DVD) standard,
one of the first and second low-density information storage media satisfies a DVD standard, the
other one of the first and second low-density information storage media satisfies a compact disc (CD) standard,
the first light is a blue-light,
one of the second and third lights is a red-light, and
the other one of the second and third lights is an infrared-light.

11. The hologram optical element of claim 6, wherein:
the first high-density information storage medium satisfies a blue-ray disc (BD) standard,
the second high-density information storage medium satisfies a high definition digital versatile disc (HD DVD) standard,
one of the first and second low-density information storage media satisfies a DVD standard,
the other one of the first and second low-density information storage media satisfies a compact disc (CD) standard,
the first light is a blue-light,
one of the second and third lights is a red-light, and
the other one of the second and third lights is an infrared-light.

12. The hologram optical element of claim 2, wherein:
the first hologram has an outer diameter so that a combination of the first hologram and the objective lens makes a numerical aperture suitable for the first low-density information storage medium with respect to the second light, and
the second hologram has an outer diameter so that a combination of the second hologram and the objective lens makes a numerical aperture suitable for the second low-density information storage medium with respect to the third light.

13. The hologram optical element of claim 12, wherein the objective lens is formed to have a numerical aperture suitable for the at least one kind of high-density information storage medium with respect to the first light.

14. The hologram optical element of claim 13, wherein:
the numerical aperture suitable for the high-density information storage medium is at least one of 0.85 and 0.65,
one of the numerical apertures suitable for the first and second low-density information storage media is 0.6, and
the other one of the numerical apertures suitable for the first and second low-density information storage media is 0.45.

15. The hologram optical element of claim 13, wherein:
the at least one kind of high-density information storage medium satisfies at least one of a blue-ray disc (BD) standard and a high definition digital versatile disc (HD DVD) standard,
one of the first and second low-density information storage media satisfies a DVD standard,
the other one of the first and second low-density information storage media satisfies a compact disc (CD) standard,
the first light is a blue-light,
one of the second and third lights is a red-light, and
the other one of the second and third lights is an infrared-light.

16. The hologram optical element of claim 1, further comprising another surface opposite to the surface having the combined hologram, the another surface comprising a first hologram which diffracts the first light by zero-th and first order diffractions,
wherein:
the zero-th order diffracted first light is transmitted through the third hologram without deflection and is focused onto a first kind of the at least one high-density information storage media having a first thickness, and
the first order diffracted first light is diverged by the third hologram and is focused onto a second kind of the at least one high-density information storage media having a second thickness other than the first thickness so that the first and second high-density information storage media having different thicknesses compatibly use the first light.

17. A compatible optical pickup usable with a received one of a high-density information storage medium, a first low-density information storage medium, and a second low-density information storage medium, the pickup comprising:
an optical system directing first, second, and third lights to the received information storage medium and detecting the first, second, and third lights reflected from the received information storage medium, the first light having a first wavelength suitable for at least one kind of the high-density information storage medium, the second light having a second wavelength suitable for the first low-density information storage medium, and the third light having a third wavelength suitable for the second low-density information storage medium;
an objective lens focusing incident light onto the received information storage medium; and
a hologram optical element disposed between the optical system and the objective lens and which, when used in combination with the objective lens, allows the compatible optical pickup to be compatibly used with the high density information storage medium, the first low-density information storage medium, and the second low-density information storage medium, the hologram optical element comprising a combined hologram on a common side of the holographic optical element and which allows the second and third lights to travel at different first and second angles for respectively focusing the second and third lights onto the first and second low-density information storage media.

18. The compatible optical pickup of claim 17, wherein:
the combined hologram comprises:
a first hologram transmitting the third light without deflection and diffracting the second light so as to focus the second light onto the first low-density information storage medium; and
a second hologram transmitting the second light without deflection and diffracting the third light so as to focus the third light onto the second low-density information storage medium,
the first and second holograms transmit the first light without deflection.

19. The compatible optical pickup of claim 18, wherein the first and second holograms are formed in a two-layer structure to have a common optical axis.

20. The compatible optical pickup of claim 19, wherein each of the first and second holograms has a stepped shape.

21. The compatible optical pickup of claim 18, wherein:
the first hologram has a maximum transmission efficiency for zero-th order diffraction of the third light, and
the second hologram has a maximum transmission efficiency for zero-th order diffraction of the second light.

22. The compatible optical pickup of claim 18, wherein:
the hologram optical element further comprises a third hologram form on another side opposite to the common side having the combined hologram so as to diffract the first light by zero-th and first order diffractions,
the zero-th order diffracted first light is transmitted through the third hologram without deflection and is focused onto a first kind of the high-density information storage medium having a first thickness, and
the first order diffracted first light is diverged by the third hologram and is focused onto a second kind of the high-density information storage medium having a second thickness other than the first thickness so that the first and second high-density information storage media having different thicknesses compatibly use the first light.

23. The compatible optical pickup of claim 22, wherein:
the first hologram has an outer diameter so that a combination of the first hologram and the objective lens makes a numerical aperture suitable for the first low-density information storage medium with respect to the second light, and
the second hologram has an outer diameter so that a combination of the second hologram and the objective lens makes a numerical aperture suitable for the second low-density information storage medium with respect to the third light.

24. The compatible optical pickup of claim 23, wherein:
the objective lens is formed to have a numerical aperture suitable for the first kind of the high-density information storage medium with respect to the zero-th order diffracted first light, and
the third hologram has an outer diameter so that a combination of the third hologram and the objective lens makes a numerical aperture suitable for the second kind of high-density information storage medium with respect to the first order diffracted first light.

25. The compatible optical pickup of claim 24, wherein:
the numerical aperture suitable for the first kind of high-density information storage medium is 0.85,
the numerical aperture suitable for the second kind of high-density information storage medium is 0.65,
one of the numerical apertures suitable for the first and second low-density information storage media is 0.6, and
the other one of the numerical apertures suitable for the first and second low-density information storage media is 0.45.

26. The compatible optical pickup of claim 22, wherein:
the first kind of high-density information storage medium satisfies a blue-ray disc (BD) standard,
the second kind of high-density information storage media medium satisfies a high definition digital versatile disc (HD DVD) standard,
one of the first and second low-density information storage media satisfies a DVD standard,
the other one of the first and second low-density information storage media satisfies a compact disc CD standard,
the first light is a blue-light,
one of the second and third lights is a red-light, and
the other one of the second and third lights is an infrared-light.

27. The compatible optical pickup of claim 18, wherein:
the first hologram has an outer diameter so that a combination of the first hologram and the objective lens makes a numerical aperture suitable for the first low-density information storage medium with respect to the second light, and
the second hologram has an outer diameter so that a combination of the second hologram and the objective lens makes a numerical aperture suitable for the second low-density information storage medium with respect to the third light.

28. The compatible optical pickup of claim 27, wherein the objective lens is formed to have a numerical aperture suitable for the at least one kind of high-density information storage medium with respect to the first light.

29. The compatible optical pickup of claim 28, wherein:
the numerical aperture suitable for the at least one kind of high-density information storage medium is at least one of 0.85 and 0.65,
one of the numerical apertures suitable for the first and second low-density information storage media is 0.6, and
the other one of the numerical apertures suitable for the first and second low-density information storage media is 0.45.

30. The compatible optical pickup of claim 17, wherein:
the hologram optical element further comprises a first hologram formed on another side opposite to the common side having the combined hologram to diffract the first light by zero-th and first order diffractions,
the zero-th order diffracted first light having the first wavelength is transmitted through the third hologram without deflection and is focused onto a first kind of the high-density information storage medium having a first thickness, and
the first order diffracted first light having the first wavelength is diverged by the third hologram and is focused onto a second kind of the high-density information storage medium having a second thickness other than the first thickness so that the first and second high-density information storage media having different thicknesses compatibly use the first light.

31. An optical information storage medium system usable with a received one of at least one kind of high-density information storage medium, a first low-density information storage medium, and a second low-density information storage medium, the system comprising:
a compatible optical pickup comprising:
an optical system directing first, second, and third lights to the received information storage medium and detecting the first, second, and third lights reflected from the received information storage medium, the first light having a first wavelength suitable for the at least one kind of high-density information storage medium, the second light having a second wavelength suitable for the first low-density information storage medium, and the third light having a third wavelength suitable for the second low-density information storage medium;
an objective lens focusing the first, second, and third lights onto the received information storage medium; and
a hologram optical element disposed between the optical system and the objective lens which, when used in combination with the objective lens, allows the optical pickup to be compatibly used with the at least one kind of high density information storage medium, the first low-density information storage medium, and the second low-density information storage medium, the hologram optical element comprising a combined hologram on one side to allow the second and third lights to travel at different first and second angles for respectively focusing the lights onto the first and second low-density information storage media, while allowing the first light to be transmitted at a third angle for focusing on the at least one kind of high-density information storage medium; and
a control unit controlling the compatible optical pickup to selectively emit the first, second, and third lights to record and/or reproduce data with respect to the received one of the at least one kind of high-density information storage medium, the first low-density information storage medium, and the second low-density information storage medium.
